(19) United States
(12) Patent Application Publication
(10) Pub. No.: US 2026/0141306 A1
(43) Pub. Date: May 21, 2026

(54) ELECTRONIC DEVICE AND METHOD WITH MODEL DETERMINATION

(71) Applicant: Samsung Electronics Co., Ltd., Suwon-si (KR)

(72) Inventors: Dong Hwan JANG, Suwon-si (KR); Sucheol LEE, Suwon-si (KR); Jiwhan KIM, Suwon-si (KR); Minsu AHN, Suwon-si (KR)

(73) Assignee: Samsung Electronics Co., Ltd., Suwon-si (KR)

(21) Appl. No.: 19/394,007

(22) Filed: Nov. 19, 2025

(30) Foreign Application Priority Data
Nov. 21, 2024 (KR) 10-2024-0167604

(51) Int. Cl. G06N 20/00

(52) U.S. Cl. CPC G06N 20/00

(57) ABSTRACT

A device and method with model determination are provided. The method includes identifying a pre-trained first model and at least one second model tuned based on the first model, for each of layers included in the first model, identifying a first weight value of the first model and at least one second weight value of the at least one second model, for each of the layers, determining a third weight value based on a location derived through a linear interpolation using a first location corresponding to the first weight value and at least one second location corresponding to the at least one second weight value that are in a weight value space, and determining a target model based on the first model including the third weight value.

### CROSS-REFERENCE TO RELATED APPLICATIONS

This application claims the benefit of Korean Patent Application No. 10-2024-0167604, filed on Nov. 21, 2024, in the Korean Intellectual Property Office, the disclosure of which is incorporated herein by reference in its entirety.

### BACKGROUND

### 1. Field

Example embodiments relate to an electronic device and method with model determination.

### 2. Description of Related Art

To obtain a model optimized for operations in a specific domain, fine-tuning can be performed using a pre-trained model based on big data as a starting point. Typically, the fine-tuned model demonstrates robust and good performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method with model determination includes identifying a pre-trained first model and at least one second model that is tuned based on the first model; for each of layers included in the first model, identifying a first weight value of the first model and at least one second weight value of the at least one second model; for each of the layers, determining a third weight value based on a location derived through a linear interpolation using a first location corresponding to the first weight value and at least one second location corresponding to the at least one second weight value that are in a weight value space; and determining a target model based on the first model comprising the third weight value.

In one general aspect, provided is a non-transitory computer-readable recording medium storing a program for executing the method described herein.

In one general aspect, an electronic device includes one or more processors; and a memory storing code that, when executed by the one or more processors, configures the one or more processors to identify a pre-trained first model and at least one second model that is tuned based on the first model; for each of layers included in the first model, identify a first weight value of the first model and at least one second weight value of the at least one second model; for each of the layers, determine a third weight value based on a location derived through a linear interpolation using a first location corresponding to the first weight value and at least one second location corresponding to the at least one second weight value that are in a weight value space; and determine a target model based on the first model comprising the third weight value.

Other features and aspects will be apparent from the following detailed description, the drawings, and the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an electronic device according to one or more embodiments;

FIG. 2 illustrates a first model, multiple second models, and a target model according to one or more embodiments;

FIG. 3 illustrates an example method of determining a third weight value using the geometric relationship of weight values in the weight value space according to one or more embodiments;

FIG. 4 illustrates another example method for determining a third weight value using the geometric relationship of weight values in a weight value space according to one or more embodiments;

FIG. 5 is a graph demonstrating the performance of a target model determined using a model determination method according to one or more embodiments; and

FIG. 6 is a flowchart illustrating a model determination method implemented by an electronic device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

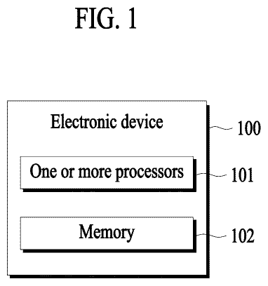

FIG. 1 illustrates an electronic device according to one or more embodiments.

Referring to FIG. 1, an electronic device 100 may include one or more processors 101 and memory 102.

The one or more processors 101 may control the overall operation of the electronic device 100. The one or more processors 101 may include at least one hardware unit. Further, the one or more processors 101 may execute one or more software modules generated by executing instructions stored in the memory 102. The one of more processors 101 may manage the one or more embodiments performed by the electronic device 100 through interaction with the memory 102 and other components of the electronic device 100.

In one or more embodiments, the one or more processors 101 may be configured to identify/select a pre-trained first model and at least one second model that has been derived from the first model through turning. For each of layers included in the first model, the processors 101 may identify a first weight value of the first model and at least one second weight value of the at least one second model. The processors 101 may then determine a third weight value based on a location derived through linear interpolation using (i) a first location corresponding to the first weight value and using (ii) at least one second location corresponding to the at least one second weight value; both weight values are in the weight value space. A target model may then be determined for each layer based on the first model having the third weight value, on a by-layer basis.

In one or more embodiments, the first model may be a pre-trained model trained on a large amount of data (e.g., a large training dataset). Specifically, the first model may be a model developed using significant computational resources and a substantial amount of training data. As a non-limiting example, the first model may be a large-scale model trained on semiconductor process-related data. Due to the time and resources of training such a large model, it may be efficient to extend the model (e.g., the first model) to operations outside the training dataset rather than having to train a new model from scratch.

In one or more embodiments, there may be multiple second models to select from, and the second models may be tuned or suitable for respectively corresponding operations/tasks. Here, the tuning process of a second model may include fine tuning, where the parameters of each layer included in the second model are adjusted to enhance performance for an operation/task specific to the second model (the second model may be based on a pre-trained model, e.g., the first model, before tuning), but the tuning is not limited thereto. The at least one second model may be adapted for operations within the same domain or for operations in different domains. For example, the at least one second model may be a tuned model suitable for a corresponding specific step in the semiconductor manufacturing process, but its applicability is not restricted to this field.

In one or more embodiments, the target model may be a model used for a target operation. Further, at least one third model may be selected from among the second models based on that performance of the selected model for the target operation satisfying a set condition. Here, the set condition may indicate that the accuracy of the target operation exceeds a predetermined value (e.g., 90%), or may indicate a set number of models (e.g., 1) that includes a top-performing model for the target operation among the second models. However, the set condition is not limited thereto.

In one or more embodiments, the previously-mentioned layers may be included in a pre-trained first model. Since the each of the second models is a model based on the first model where only the weight value is tuned, each second model may be structurally identical to the first model (e.g., may have a same network structure). In other words, the layers included in the first model may respectively correspond to the layers included in each of the second models.

In one or more embodiments, the linear interpolation may be a technique for determining a plot or point of any one of the locations on a simplex including multiple locations. More specifically, the simplex projection technique may be applied in conjunction with linear interpolation to determine one plot (e.g., a specific plot). When the multiple locations included in the simplex are two plots, the plot, estimated through linear interpolation, may be any one plot along the straight line connecting the two locations.

In one or more embodiments, the weight value space may be a multidimensional space where the weight values of a layer are located. The dimension of the weight value space of a layer may be the number of weight values contained in the layer. For example, when the layers are convolution layers, the number of weight values included in a convolution layer may be calculated as the product of the kernel size k×k, the number of input channels cᵢₙ, and the number of output channels cₒᵤₜ. However, the number of weight values is not limited thereto.

The second weight value of the second model may correspond to a plot in the weight value space. More specifically, the plot corresponding to the second weight value may be located on the weight value distribution, where the weight value of the second model may be located. In one or more embodiments, the weight value distribution may include a plurality of training orders of data used to train the second model from the pre-trained first model or weight values of the second model that change based on the strength of the reinforcement technique applied. More specifically, by modifying the training orders or adjusting the strength of the reinforcement technique, the weight values of the second model may be optimized for different trajectories. For example, the weight value distribution in the weight value space may take the form of a thin shell centered on a specific plot. However, the weight value distribution is not limited thereto.

The memory 102 may store one or more instructions to be executed by the one or more processors 101. The memory 102 may be referred to as storage and may be volatile memory or non-volatile memory. The memory 102 may store various information for performing the model determination method. For example, the memory 102 may store data related to a pre-trained first model, at least one second model, and training data associated with the models stored in the memory 102.

According to example embodiments, it is possible for an electronic device to determine a target model with an optimal weight value suitable for the target operation by using a pre-learned first model and at least one second model tuned based on the first model. In other words, according to example embodiments, since the weight values of at least one second model are linearly combined at an optimal ratio rather than simply linearly combined, the target model determined by the electronic device may be a model optimized for the target operation.

According to example embodiments of the present disclosure, it is possible for an electronic device to obtain a target model with finely tuned weight values for each layer to suit the target operation since optimal weight value is determined for each layer. Further, since at least one second model is a tuned model based on the pre-trained first model, even if at least one second model is a model tuned to be suitable for different domains or different operations, the electronic device can determine a target model suitable for a target operation using at least one second model.

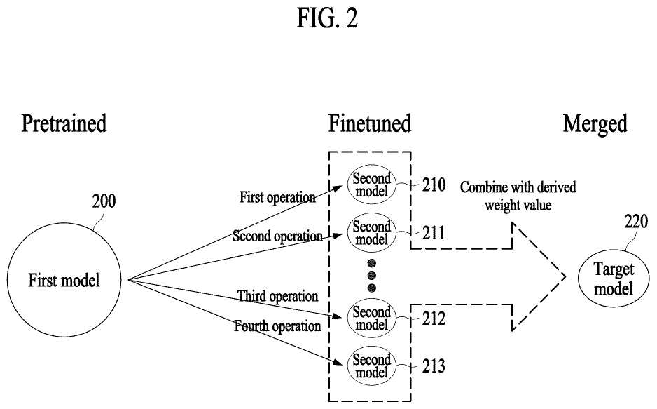

FIG. 2 illustrates a first model, multiple second models, and a target model according to one or more embodiments.

In one or more embodiments, a first model 200 may be a pre-trained model trained on a large amount of data. Since the first model is developed using extensive data from various domains, the first model may serve as a suitable starting model (e.g., template) for the fine tuning process.

In one or more embodiments, each of multiple second models 210, 211, 212 and 213 may be fine-tuned versions of the first model 200, optimized for specific operations/tasks. For example, the second model 210 may be a model fine-tuned to be suitable for the first operation/task, the second model 211 may be a model fine-tuned to be suitable for the second operation/task, the second model 212 may be a model fine-tuned to be suitable for the third operation/task, and the second model 213 may be a model fine-tuned to be suitable for the fourth operation/task. Although the second models 210, 211, 212 and 213 are derived from the first model 200, each second model may possess distinct weight values due to the fine-tuning process.

In one or more embodiments, the second models may be a fine-tuned model for specific processes, such as those involved in semiconductor manufacturing, but the second models are not limited thereto. The second models may include multiple fine-tuned models, each trained under different reward conditions.

In one or more embodiments, the at least one second model may satisfy the condition for linear mode connectivity. The linear mode connectivity may mean that the property of minimizing loss is maintained/preserved when at least one second model is linearly combined. In general, the more structurally similar models are, the smaller the differences in weight values outside a set range, and the more similar the trajectories are trained, the more likely it is that the condition for linear mode connectivity will be satisfied.

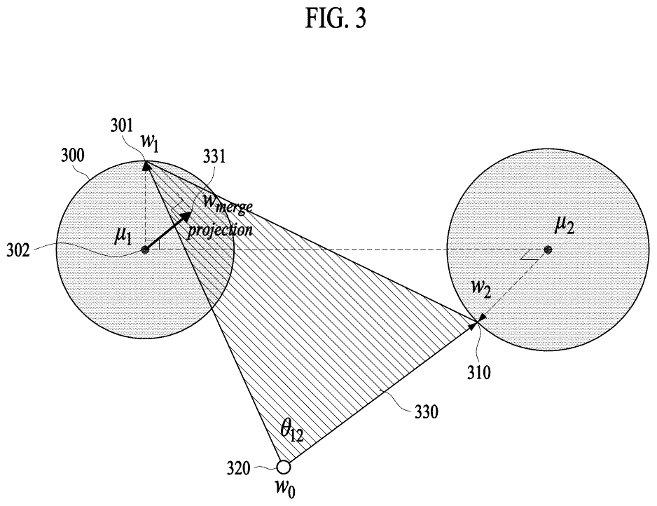

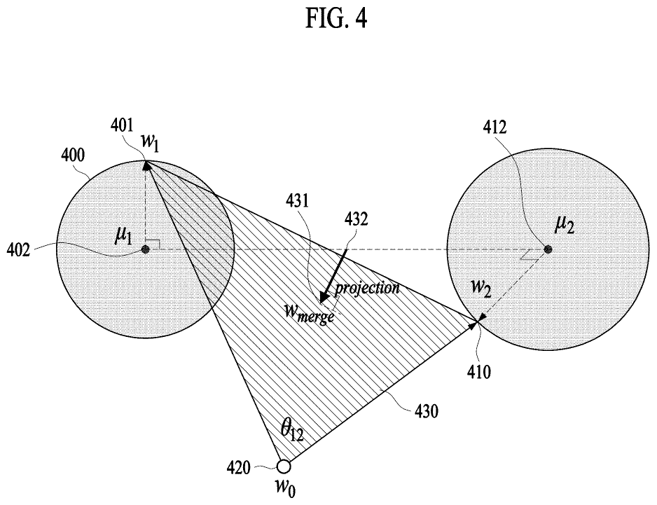

In one or more embodiments, a target model 220 may be constructed to be used for a specific target operation. More specifically, the target model 220 may have an optimal weight value since it is generated by combining a second model with the derived weight value. With regard thereto, even if the second models 210,211,212 and 213 are fine-tuned based on the first model 200 to be suitable for the specific operations (e.g., a first operation through a fourth operation), new operations may be required as target operations due to process modifications or additions (e.g., manufacture process modifications). In such cases, rather than performing a new fine tuning of the first model 200 for the new target operation, the electronic device 100 may obtain the target model 220 (which is suitable for the target operation) by using a second model that has already been fine-tuned (i.e., leveraging an existing fine-tuned second model). Described below with reference to FIG. 3 and FIG. 4 are methods for deriving a third weight value using geometric relationships in the weight value space.

FIG. 3 illustrates a method of determining a third weight value using the geometric relationship of weight values in the weight value space according to one or more embodiments. More specifically, FIG. 3 demonstrates how to determine w_{merge}, the third weight value of the layer included in the first model.

As described above, the target model may be a model used for a target operation. In one or more embodiments, the electronic device 100 may identify/generate a third model whose performance for a target operation meets/satisfies a set condition, among at least one of second models. The performance of the target operation for at least one second model may be determined in advance, but is not limited thereto. When there is no prior information available regarding the performance of the target operation for at least one second model, the electronic device 100 may first obtain the performance using test data specific to the target operation.

A target operation may contain only one operation, and a third model whose performance for the target operation meets a set condition may contain only one second model. FIG. 3 illustrates that there is only a single third model identified by the electronic device 100. For example, the second model with the second weight value, w₁, may be a model whose performance for the target operation satisfies the set condition, and the second model with the second weight value, w₂, may be a model whose performance for the target operation does not satisfy the set condition. In other words, the second model with the second weight value, w₁, may be both a second model and the third model.

In one or more embodiments, the electronic device 100 may identify a first location corresponding to a first weight value and at least one second location corresponding to at least one second weight value, in a weight value space. In the weight value space, the location corresponding to the first weight value, w₀, may be a first location 320, and the locations corresponding to the second weight values which are w₁ and w₂ may be second locations 301 and 310.

In one or more embodiments, the electronic device 100 may identify a weight value distribution 300 where the weight values of the third model may be located in the weight value space. Referring to FIG. 3, the weight value distribution 300 may be in the form of a thin shell, but is not limited thereto.

In one or more embodiments, the weight value distribution 300 may be estimated based on weight values obtained by adjusting various training orders/sequences related to the third model and/or the strength of the reinforcement technique. For example, the second weight value, w₁, may be a weight value derived when the first training data is used for initial learning, followed by the second training data. Conversely, a different weight value may be obtained if the training order is reversed, with the second training data used first and the first training data used afterward. By varying the training orders and/or modifying the strength of the reinforcement technique, the electronic device 100 may generate a diverse set of weight values beyond the second weight value w₁. At this stage, the electronic device 100 may estimate the weight value distribution 300 based on the locations/positions of this large number of weight values within the weight value space. Since estimating the weight value distribution 300 can be resource-intensive, this process may not be performed for the third model that is not selected from the at least one of second models. However, for convenience of explanation, FIG. 3 also illustrates the weight value distribution where the second weight value, w₂, is located.

In one or more embodiments, the electronic device 100 may identify the location corresponding to the weight value distribution 300. For example, the location corresponding to the weight value distribution 300 may be a third location 302, which is the center u₁ of the weight value distribution 300. However, the location corresponding to the weight value distribution 300 is not limited thereto.

In one or more embodiments, the electronic device 100 may identify a simplex in a weight value space that includes a first location and at least one second location. For example, simplex 330 might be a planar area containing the first location 320 and the second locations 301 and 310, but is not limited thereto.

In one or more embodiments, the locations derived through linear interpolation using the first location and at least one second location may be positioned on the simplex. In this context, the electronic device 100 may determine the third weight value corresponding to the projected location by projecting the third location onto the simplex. For example, the electronic device 100 may determine the third weight value, w_{merge}, corresponding to a projected location 331 by projecting the third location 302 to the simplex 330. Referring to Equation 1 below, the third weight value, w_{merge}, may be computed as a linear combination of the second weight values, w₁ and w₂.

$${w}_{merge} = s \times {w}_{1} + t \times {w}_{2} \qquad Equation 1$$

Specifically, the coefficients s and t may be computed based on conditional expressions related to the simplex projection. Referring to Equation 2 for example below, the conditional expression related to the simplex projection may include four conditional expressions as follows

$$\begin{matrix}Equation 2 & \\ ( {U}_{1} - {W}_{merge} ) \cdot {W}_{1} = 0 & ( 1 )\end{matrix}$$

$$( {U}_{1} - {W}_{merge} ) \cdot {W}_{2} = 0 \qquad ( 2 )$$

$$for i \neq j , {W}_{i} \cdot {W}_{j} = {U}_{i} \cdot {W}_{j} = {U}_{i} \cdot {U}_{j} \qquad ( 3 )$$

$$for i = j , {W}_{i} \cdot {W}_{i} = {‖ {W}_{i} ‖}^{2} \neq {‖ {U}_{i} ‖}^{2} \qquad ( 4 )$$

Here, U₁ is a vector from the first location 320 to the third location 302, W_{merge} is a vector from the first location 320 to the projected location 331, W₁ is a vector from the first location 320 to the second location 301, and W₂ is a vector from the first location 320 to the second location 310. For example, the first and second conditions indicate that the vector from the third location 302 to the projected location 331 is orthogonal to any vector on the simplex 330.

Regarding the coefficients s, t, referring to Equation 3 below, the coefficients s, t may be calculated as follows.

$$S = \frac{cos {θ}_{1} - {cos}^{2} {θ}_{12}}{1 - {cos}^{2} {θ}_{12}} , t == \frac{‖ {W}_{1} ‖ cos {θ}_{12} ( 1 - cos {θ}_{1} )}{‖ {W}_{2} ‖ ( 1 - {cos}^{2} {θ}_{12} )} \qquad Equation 3$$

Here, θ₁₂ may represent the angle between W₁ and W₂. Further, when two vectors from the third location 302 to the two locations P₁ and P₂ on the weight value distribution 300, and a vector from the third location 302 to the first location 320 are orthogonal to each other, θ₁ represents the angle between two vectors from the first location 320 to the two locations P₁ and P₂.

In one or more embodiments, the projected location 331 may be a location resulting from projecting the third location 302 onto the simplex 330. In other words, d₁, the distance from the third location 302 to the projected location 331, may be shorter than or equal to d₂, the distance from the third location 302 to the second location 301. The weight values corresponding to locations with a short distance from the third location 302, which is the center of the weight value distribution, may indicate that the loss value calculated based on the learning data is small. The third weight value, w_{merge}, may be a more optimized weight value for the target operation. In other words, the target model with the third weight value, w_{merge}, may be a model predicted to perform better in the target operation than the second model with the second weight value, w₁.

In this way, even without investing a large amount of computational resources through fine tuning, the electronic device 100 may effectively determine a target model that is more suitable for the target operation using the first model, which is a pre-trained large model, and the fine-tuned at least one second model.

FIG. 4 illustrates a method for determining a third weight value using the geometric relationship of weight values within a weight value space, according to one or more embodiments.

In one or more embodiments, among at least one second model, multiple third models may satisfy a set condition for a target operation. In one or more embodiments, when the target operation includes a plurality of operations, the electronic device 100 may identify multiple third models whose performance meets a set condition for one of the plurality of operations, among at least one second model. FIG. 4 illustrates two identified third models. Further, detailed explanations overlapping with those described in FIG. 3 are omitted for brevity.

In one or more embodiments, a weight value distribution 400 may correspond to the weight value distribution 300, a first location 420 may correspond to the first location 320, and second locations 401 and 410 may correspond to the second locations 301 and 310, respectively. Simplex 430 may correspond to the simplex 330. Additionally, a location 402 may correspond to the third location 302. Since FIG. 4 illustrates two identified third models, the second model with the second weight value, w₂, may serve as both a second model and a third model.

The electronic device 100 may identify, for each of a plurality of third models, multiple weight value distributions where the weight values of each of the plurality of third models may reside in the weight value space. The weight value distribution for the second model with the second weight value, w₂, may also be estimated in a similar way to the weight value distribution 400 for the second model with the second weight value w₁. Accordingly, a location 412, representing the center of the weight value distribution for the second model with the second weight value, w₂, may be identified.

When multiple third models exist, third locations may be identified based on the centers of weight value distributions corresponding to these third models. Specifically, the third location may be calculated as the average of the plurality of locations. For example, a third location 432 may correspond to the center plot (or the midpoint) between the location 402 and the location 412, but is not limited thereto.

The electronic device 100 may determine the third weight value, w_{merge}, corresponding to a projected location 431 by projecting the third location 432 onto the simplex 430. The third weight value, w_{merge}, may be computed as a linear combination of at least one second weight value, w₁ and w₂.

The projected location 431 may be the location resulting from projecting third location 432 onto the simplex 430. In other words, d₁, the distance from the third location 432 to the projected location 431, may be shorter than or equal to d₂, which is the distance from the third location 432 to the second location 401, and d₃, which is the distance from the third location 432 to the second location 410. Consequently, when considering the overall performance of multiple operations, the target model with the third weight value, w_{merge}, may be a model predicted to outperform the second models with the second weight values w₁ and w₂.

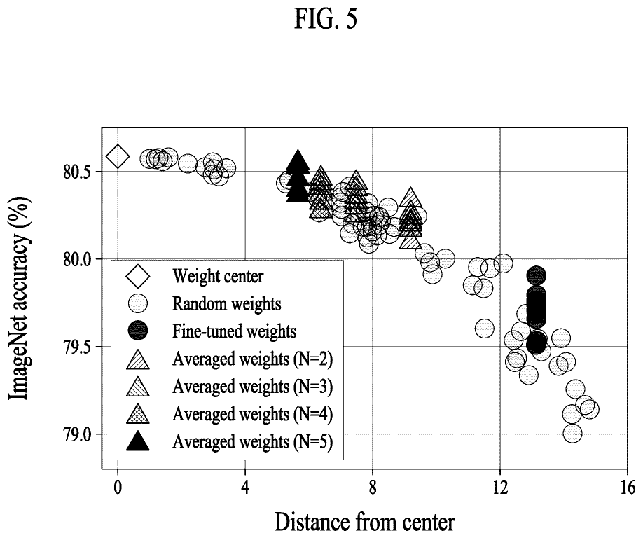

Since the method of determining the third weight value using the geometric relationship of the weight values in the weight value space is performed for each layer of the first model, the weight values for all layers of the target model may be determined as the third weight values. The performance of the target model is examined in detail with reference to FIG. 5.

FIG. 5 is a graph demonstrating the performance of a target model determined using the disclosed model determination method according to one or more embodiments. The target operation may include wafer defect detection, and the graph may depict the accuracy of detecting defects in a test image data set by the target model compared to other methods. However, the target operation is not limited to wafer defect detection, and may include various tasks, including image classification.

The defect detection accuracy of the target model determined by the model determination method may exceed that of models determined by other methods. More specifically, the fault detection accuracy of the target model may surpass the fault detection accuracy of a second model fine-tuned to perform the target operation and the fault detection accuracy of a model that is a simple linear combination of two or more fine-tuned second models. Referring to FIG. 5, a model formed by a simple linear combination of multiple fine-tuned second models exhibits improved performance as the number of second models increases. However, there may be limitations in requiring a large number of second models to improve performance for the target operation through simple linear combination. In contrast, the target model determined by the model determination method may exhibit relatively high performance in the target operation when the optimized weight value is determined based on a relatively small number of second models.

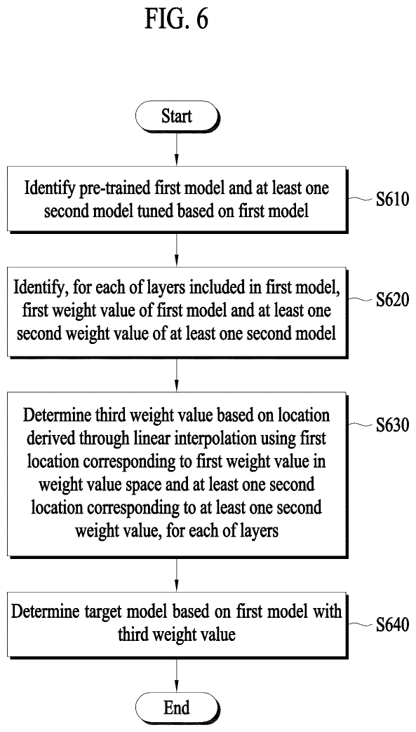

FIG. 6 is a flowchart illustrating a model determination method implemented by an electronic device according to one or more embodiments.

Referring to FIG. 6, individual operations of the model determination method may be modified, substituted, or reordered within a scope understandable to a person having ordinary skill in the art.

In operation S610, the electronic device 100 may identify a pre-trained first model and at least one second model tuned based on the first model.

In one or more embodiments, the first model may be a pre-trained model derived from a large amount of data. Each second model may be tuned to optimize performance for the corresponding tasks. The at least one second model may be a fine-tuned version of the first model, with adjustments made to each parameter of each of layers included in the first model.

In operation S620, the electronic device 100 may identify, for each of the layers included in the first model, a first weight value of the first model and at least one second weight value of at least one second model.

In one or more embodiments, the first weight value may be the weight value of a pre-trained model trained on a large amount of data. The second weight value may be a weight value optimized for specific operations derived from training data related to the respective second model.

In operation S630, the electronic device 100 may determine a third weight value based on a location derived through linear interpolation using the first location corresponding to the first weight value in the weight value space and at least one second location corresponding to at least one second weight value, for each of the layers.

In one or more embodiments, the electronic device 100 may identify a weight value distribution in which the weight values of the third model may be located within the weight value space, and determine the third location corresponding to the weight value distribution. The electronic device 100 may determine a third weight value corresponding to the projected location by identifying a simplex in the weight value space that includes the first location and at least one second location, and projecting the third location onto the simplex.

When only one third model exists, the electronic device 100 may identify a weight value distribution where a weight value of a third model may be located in a weight value space, and determine a third location corresponding to the weight value distribution. The third location may be the center of the weight value distribution.

When the target operation includes the plurality of operations, the electronic device 100 may identify multiple third models of which performance satisfies a set condition for any one of the sub-operations among at least one second model. When multiple third models satisfy the set condition for the target operation, the third location may be determined based on the centers of their respective weight value distributions where a weight value of each of the multiple third models may be located. For example, the third location may be determined as a middle plot of the plurality of locations corresponding to the plurality of centers.

In operation S640, the electronic device 100 may determine a target model based on the first model with the third weight value.

In one or more embodiments, the electronic device 100 may obtain a target model using a first model having a third weight value determined in operation S640. The electronic device 100 may perform a target operation using the acquired target model. As described with reference to FIG. 5, a target model determined by the model determination method may exhibit superior performance for target operations compared to models determined by other methods.

The electronic device 100 may include one or more processors, a memory for storing and executing program data, a permanent storage (e.g., a disk drive), and/or a user interface device (e.g., communication port, touch panel, keys and/or buttons for external communication). Methods implemented as software modules or algorithms may be stored as computer-readable codes in a computer-readable medium (e.g., ROM, RAM, floppy disk, hard disk, CD-ROM, or DVD). Additionally, the computer-readable medium may be network-distributed, allowing execution in a distributed manner across network-connected systems.

The examples and embodiments may be represented by functional block elements and various processing steps. The functional blocks may be implemented in any number of hardware and/or software configurations (e.g., as code/instructions) that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing.

The computing apparatuses, the electronic devices, the processors, the memories, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software include higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method with model determination executed by an electronic device, the method comprising:
identifying a pre-trained first model and at least one second model that is tuned based on the first model;
for each of layers included in the first model, identifying a first weight value of the first model and at least one second weight value of the at least one second model;
for each of the layers, determining a third weight value based on a location derived through a linear interpolation using a first location corresponding to the first weight value and at least one second location corresponding to the at least one second weight value that are in a weight value space; and
determining a target model based on the first model comprising the third weight value.

2. The method of claim 1, wherein the target model is configured for a target operation, and further comprising identifying a third model, among the at least one second model, wherein performance for the target operation satisfies a set condition.

3. The method of claim 2, wherein the determining of the third weight value comprises:
identifying a weight value distribution in which a weight value of the third model resides in the weight value space; and
identifying a third location corresponding to the weight value distribution.

4. The method of claim 3, wherein the determining of the third weight value further comprises:
identifying a simplex in the weight value space comprising the first location and the at least one second location; and
determining the third weight value corresponding to a projected location by projecting the third location onto the simplex.

5. The method of claim 3, wherein, when a single third model is present, the third location corresponds to a center of the weight value distribution.

6. The method of claim 3, wherein, when a plurality of third models are present, the identifying of the weight value distribution comprises:
for each of the plurality of third models, identifying a plurality of weight value distributions in which a weight value of each of the plurality of third models resides in the weight value space, and
wherein the third location is based on a plurality of centers corresponding to the plurality of weight value distributions.

7. The method of claim 3, wherein, when the target operation comprises a plurality of operations, the identifying of the third model comprises:
identifying a plurality of third models among the at least one second model, wherein each of the plurality of third models satisfies the set condition for the performance of at least one of the plurality of operations.

8. The method of claim 7, wherein the identifying of the weight value distribution comprises:
for each of the plurality of third models, identifying a plurality of weight value distributions in which a weight value of each of the plurality of third models resides in the weight value space, and
wherein the third location is based on a plurality of centers corresponding to the plurality of weight value distributions.

9. The method of claim 2, wherein each of the at least one model is tuned for different operations.

10. The method of claim 9, wherein the target operation is an operation for semiconductor defect detection, and
wherein each of the at least one second model is tuned for operations related to semiconductor processing.

11. The method of claim 1, wherein the at least one second weight value satisfies a condition for linear mode connectivity.

12. The method of claim 3, wherein the weight value distribution comprises a plurality of weight values identified based on a plurality of training orders of data used to train the third model.

13. The method of claim 2, further comprising performing the target operation using the target model.

14. A non-transitory computer-readable recording medium storing a program for executing the method of claim 1 on a computer.

15. An electronic device, comprising:
one or more processors; and
a memory storing code that, when executed by the one or more processors, configures the one or more processors to:
identify a pre-trained first model and at least one second model that is tuned based on the first model;
for each of layers included in the first model, identify a first weight value of the first model and at least one second weight value of the at least one second model;
for each of the layers, determine a third weight value based on a location derived through a linear interpolation using a first location corresponding to the first weight value and at least one second location corresponding to the at least one second weight value that are in a weight value space; and
determine a target model based on the first model comprising the third weight value.

16. The electronic device of claim 15, wherein the target model is configured for a target operation, and
wherein the one or more processors are further configured to identify a third model, among the at least one second model, wherein performance of the third model for the target operation satisfies a set condition.

17. The electronic device of claim 16, wherein the one or more processors are further configured to:
identify a weight value distribution in which a weight value of the third model resides in the weight value space; and
identify a third location corresponding to the weight value distribution.

18. The electronic device of claim 17, wherein the one or more processors are further configured to:
identify a simplex in the weight value space comprising the first location and the at least one second location; and
determine the third weight value corresponding to a projected location by projecting the third location onto the simplex.

19. The electronic device of claim 17, wherein, when a single third model is present, the third location corresponds to a center of the weight value distribution.

20. The electronic device of claim 17, wherein, when the target operation comprises a plurality of operations, the one or more processors are further configured to:
identify a plurality of third models among the at least one second model, wherein each of the plurality of third models satisfies the set condition for the performance of at least one of the plurality of operations; and
for each of the plurality of third models, identify a plurality of weight value distributions in which a weight value of each of the plurality of third models resides in the weight value space,
wherein the third location is based on a plurality of centers corresponding to the plurality of weight value distributions.
